(19) United States
(12) Patent Application Publication
(10) Pub. No.: US 2025/0284448 A1
(43) Pub. Date: Sep. 11, 2025

(54) CONTENT SHARING SYSTEM AND METHOD FOR SHARING PRESENTING DATA

(71) Applicants: BARCO N.V., Kortrijk (BE); BARCO LIMITED, New Taipei City (TW)

(72) Inventors: Chen-Way LU, Taipei City (TW); Chia-Hsin LIEN, Taipei City (TW); Oliver Emmanuel C. VAN CAMP, Bever (BE); Tsung-Hsun LIN, New Taipei City (TW); Wen-Chieh LEE, Taoyuan City (TW)

(73) Assignees: BARCO N.V., Kortrijk (BE); BARCO LIMITED, New Taipei City (TW)

(21) Appl. No.: 18/862,711

(22) PCT Filed: May 3, 2022
(86) PCT No.: PCT/EP2022/061878

§ 371 Date: Nov. 4, 2024

(51) Int. Cl. G06F 3/14; G06F 9/451

(52) U.S. Cl. CPC G06F 3/1454; G06F 9/451

(57) ABSTRACT

A content sharing system and a method for sharing a presenting data are disclosed. The content sharing system shares the presenting data between a presentation device and a processing device. The content sharing system are configured to monitor applications of the processing device; identifying contents of the applications having priority; generating presenting data of contents; translating the presenting data to form a presenting signal; and transmitting the presenting signal to the presentation device.

### BACKGROUND OF THE INVENTION

### 1. Field of the Invention

The present disclosure generally relates to a content sharing system, in particular to a content sharing system that determine and contents having priority.

### 2. Description of the Prior Arts

As the demand for remote communication increases, there is a decrease in-person social interaction. There is a need to improve on interactive features of the content sharing systems. In this way, a bridge between online interaction and in-person social interaction can be bridged closer to each other.

To overcome the shortcomings, the present invention provides a to mitigate or to obviate the aforementioned problems.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1A illustrates an arrangement of devices in a content sharing system according to an embodiment of the present disclosure;

FIG. 1B illustrates another arrangement of devices in a content sharing system according to another embodiment of the present disclosure;

FIG. 1C illustrates another arrangement of devices in a content sharing system according to an embodiment of the present disclosure;

FIG. 1D illustrates another arrangement of devices in a content sharing system according to an embodiment of the present disclosure;

FIG. 2A illustrates an arrangement of devices in a content sharing system according to another embodiment of the present disclosure;

FIG. 2B illustrates another arrangement of devices in a content sharing system according to an embodiment of the present disclosure;

FIG. 2C illustrates another arrangement of devices in a content sharing system according to an embodiment of the present disclosure;

FIG. 2D illustrates another arrangement of devices in a content sharing system according to an embodiment of the present disclosure;

FIG. 3 illustrates a system block diagram of a content sharing system according to an embodiment of the present disclosure;

FIGS. 4(a) to 4(e) illustrate a display image arrangement according to an embodiment of the present disclosure;

FIG. 5 illustrates a system block diagram of a content sharing system according to another embodiment of the present disclosure;

FIGS. 6(a) to (c) illustrate different display image arrangements according to other embodiments of the present disclosure;

FIG. 7 illustrates a system block diagram of a content sharing system according to another embodiment of the present disclosure;

FIG. 8 illustrates a communication application according to an embodiment of the present disclosure;

FIG. 9 illustrates a flowchart of the operation of the processing device according to an embodiment of the present disclosure;

FIG. 10 illustrates a flowchart of the operation of the base unit according to an embodiment of the present disclosure; and

FIG. 11 illustrates another flowchart of the operation of the base unit according to an embodiment of the present disclosure.

### DETAILED DESCRIPTION OF THE EMBODIMENTS

The present disclosure will now be described more fully hereinafter with reference to the accompanying drawings, in which exemplary embodiments of the disclosure are shown. This disclosure may, however, be embodied in many different forms and should not be construed as limited to the exemplary embodiments set forth herein. Rather, these exemplary embodiments are provided so that this disclosure will be thorough and complete, and will fully convey the scope of the disclosure to those skilled in the art. Like reference numerals refer to like elements throughout.

The terminology used herein is for the purpose of describing particular exemplary embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

During a presentation using a communication application, a processing device is configured to transmit a content such as an image to a presentation device. A user of the processing device is required to select a particular content to be subsequently shared to the presentation device.

Alternatively, to selecting particular content, the user can share the desktop of the processing device comprising a plurality of windows. In this case, there are some windows of the processing device that are displayed that are deemed non-relevant or inappropriate content for the ongoing presentation. Further, the user is left vulnerable to exposing private or confidential information.

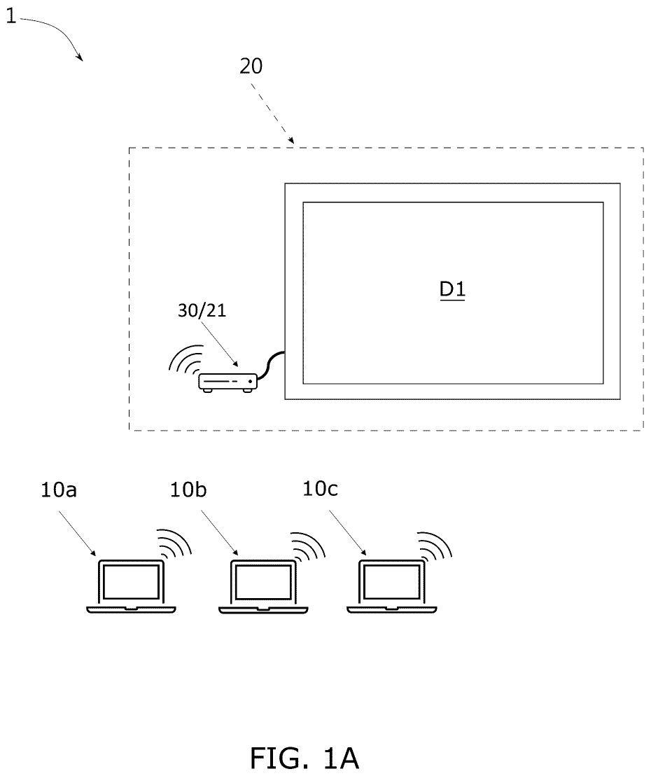

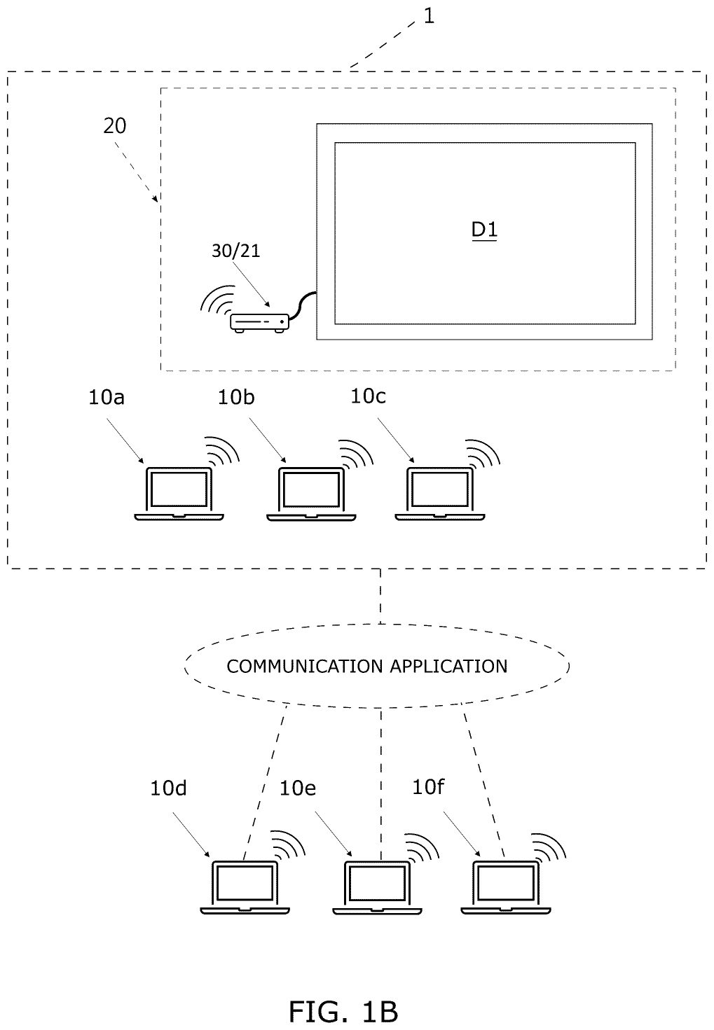

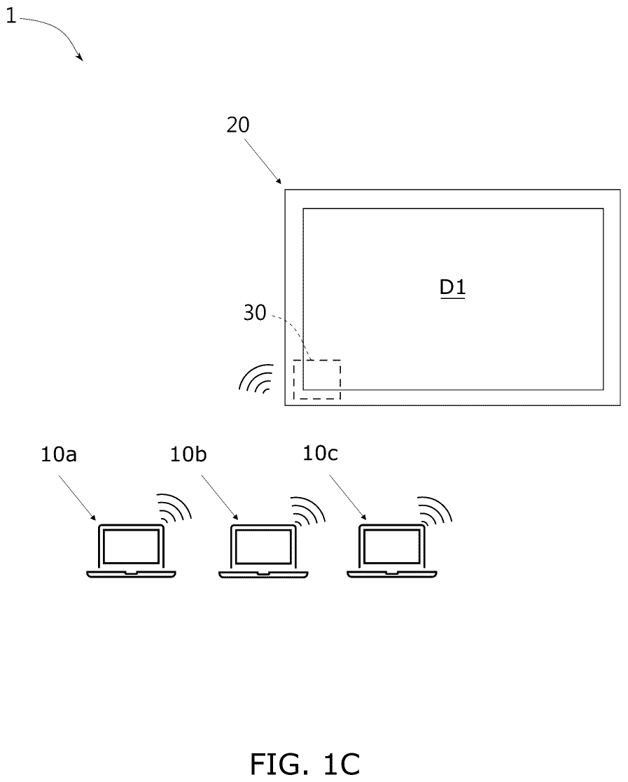

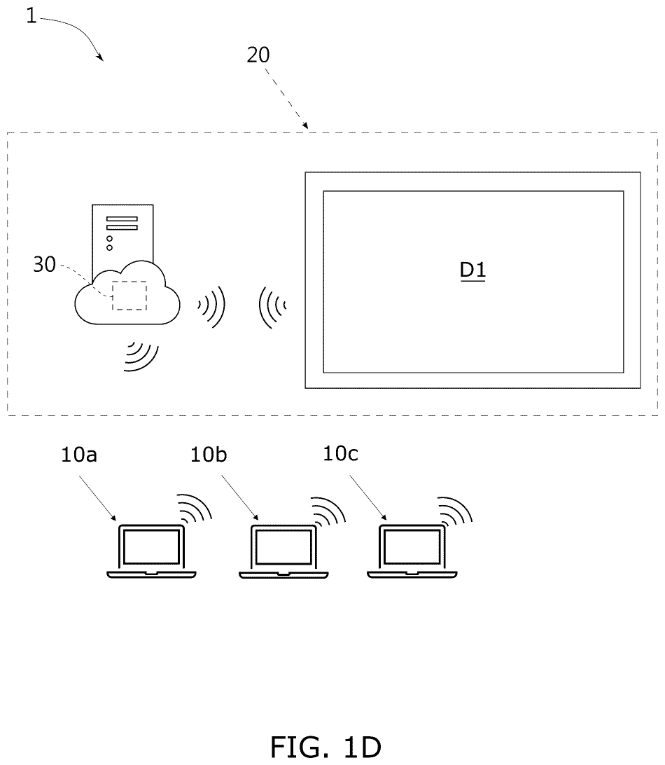

FIGS. 1 to 11 and corresponding descriptions illustrate embodiments of the disclosure configured to provide an automated process to identify relevant content, prioritize and filter the relevant contents, adapt the relevant content for optimal presentation and transmit to a presentation device. Further, the embodiments of the present disclosure, does not require specific user actions whilst still offering an adaptive and context sensitive user experience.

FIGS. 1A to 1D illustrate arrangements of devices in a content sharing system 1 according to embodiments of the present disclosure. The content sharing system 1 includes a plurality of processing devices 10a, 10b, and 10c, and a presentation device 20. The devices in the content sharing system 1 are connected through a network. Any one of the processing devices 10a, 10b, and 10c generates at least one presenting signal. The presenting signal may include data of at least one of an audio signal or a presenting image. In some embodiments, the at least one presenting signal is transmitted to the presentation device 20. In some embodiments, the processing devices 10a, 10b, and 10c located in the vicinity of the presentation device 20. Further, as shown in FIG. 1B, a plurality of processing devices 10d, 10e, and 10f other than the processing devices 10a, 10b, and 10c may be located remotely and connected to the content sharing system 1 through a communication application.

In some embodiments, the content sharing system 1 further includes a base node 30 configured to receive and process the presenting signal. In an exemplary embodiment, as in FIG. 1A, the content sharing system 1 further includes at least one base unit 21 electrically coupled to the presentation device 20 or a display unit DI configured to perform function of a base node 30 of the content sharing system 1. Wherein, the display unit DI may be a presentation device 20 only configured for display use. In another exemplary embodiment, the base unit 21 is further coupled to at least one of a webcam or camera, a speaker, and a microphone. In further embodiments, with reference to FIG. 1C, the presentation device 20 may further include a base node 30 built within the presentation device 20. The presentation device 20 may serve as a base node of the content sharing system 1. In further exemplary embodiment, as shown in FIG. 1D, the presentation device 20 is connected to the base node 30 of the content sharing system 1 via a wireless network connection. In an exemplary embodiment, the base node 30 may be located in a server that can be accessed through a network connection. In some embodiments, the presentation device 20 is equipped with configurable properties that can be controlled via device control data. Therefore, the base node 30 may exist in different form or location, but be used as connection between anyone of the processing devices 10a to 10C and the presentation device 20.

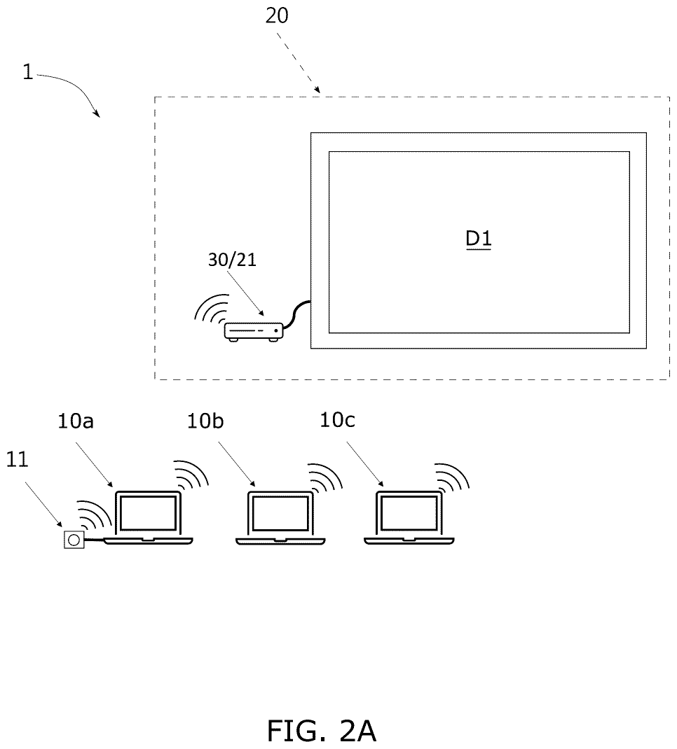

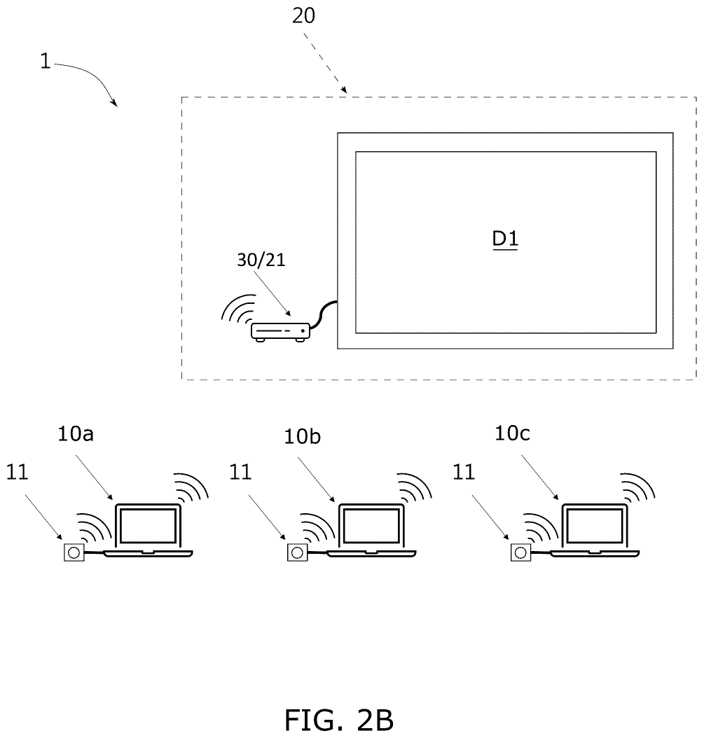

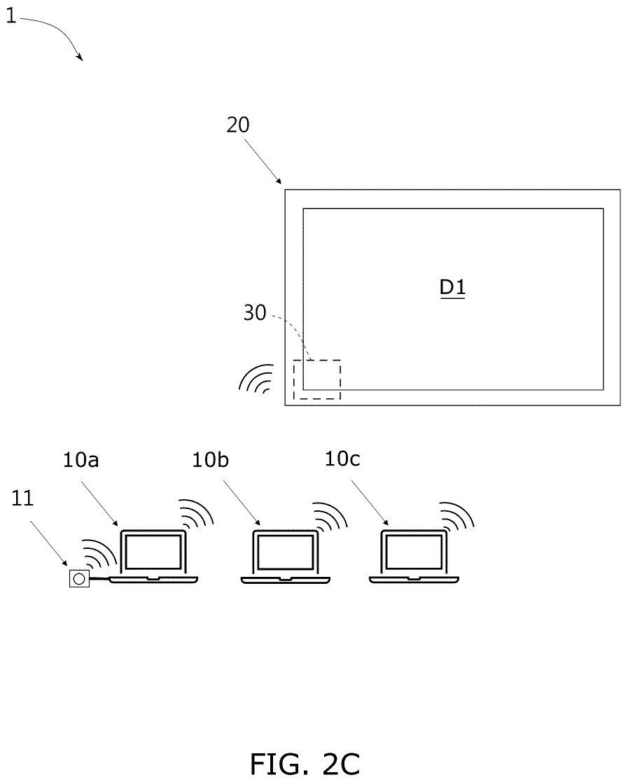

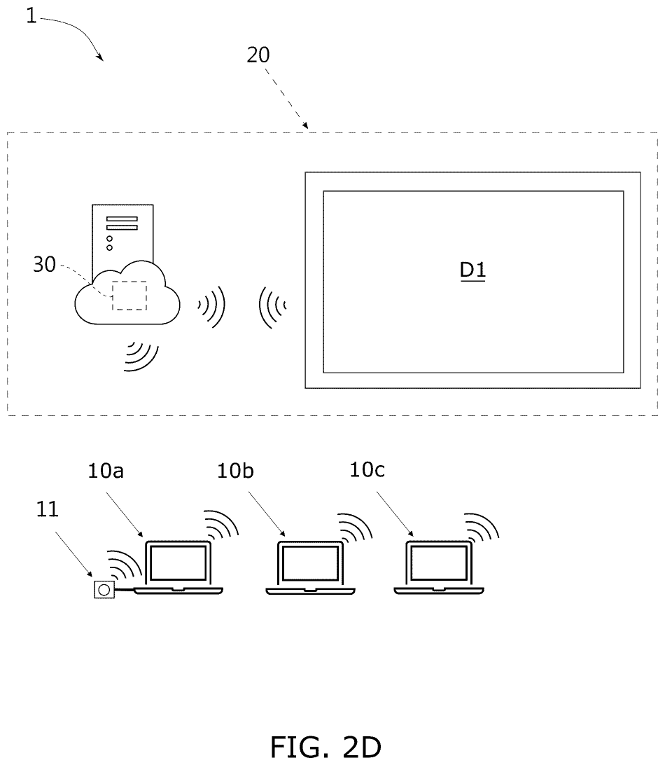

FIGS. 2A to 2D illustrates different arrangements of devices in a content sharing system 1 according to another embodiment of the present disclosure. In some embodiments, the content sharing system 1 further includes a peripheral device 11 electrically coupled to a processing device 10a. The peripheral device 11 may be further connected to the base node 30 of the content sharing system 1 through the network. In some other embodiments, the peripheral device 11 is further paired with the presentation device 20 through the base node 30. The peripheral device 11 is configured to activate or execute the sharing of presenting signals between the processing device 10a and the presentation device 20. In some embodiments, the peripheral device 11 transmits the presenting signal from the processing device 10a to a base unit 21 of the presentation device 20, wherein the base unit 21 electrically coupled to the presentation device 20 to perform function of the base node 30 of the content sharing system 1. In some other embodiments, with reference to FIGS. 2A-2D, the peripheral device 11 transmits a pairing signal with the presentation device 20 through a base node 30, while a transceiver 105 of the processing device 10a is configured to transmit the presenting signal from the processing device 10a to the presentation device 20 through the base node 30. In further embodiments, as shown in FIG. 2B, more than one peripheral device 11 is correspondingly coupled to the processing devices 10a, 10b, and 10c. In some embodiments, the presenting signal further includes data having at least one of location, resolution, and sizing information. In some embodiments, the presentation device 20 includes a processor 210 and a transceiver 211 configured to perform function of a base node of the content sharing system 1. In further embodiments, the presentation device 20 is further coupled to at least one of a webcam or camera, a speaker, and a microphone.

In some embodiments, as shown in FIGS. 2A and 2B, the base node 30 is in the form of a base unit 21 that is connected or paired to the presentation device 20. In some embodiment, as shown in FIGS. 2C, the peripheral device 11 may be further connected to the base node 30 of the content sharing system 1 and the base node 30 may be built within the presentation device 20. The presentation device 20 may receive the presenting signal through the base node 30. In an exemplary embodiment, a presentation device having a processor (such as presentation device 20) may serve as a base node 30 of the content sharing system 1. In further exemplary embodiment, as shown in FIG. 2D, the peripheral device 11 may be further connected to the base node 30 of the content sharing system 1 and the base node 30 may be located in a server that can be accessed through a network connection. In the same way, the presentation device 20 may receive a presenting signal through the base node 30.

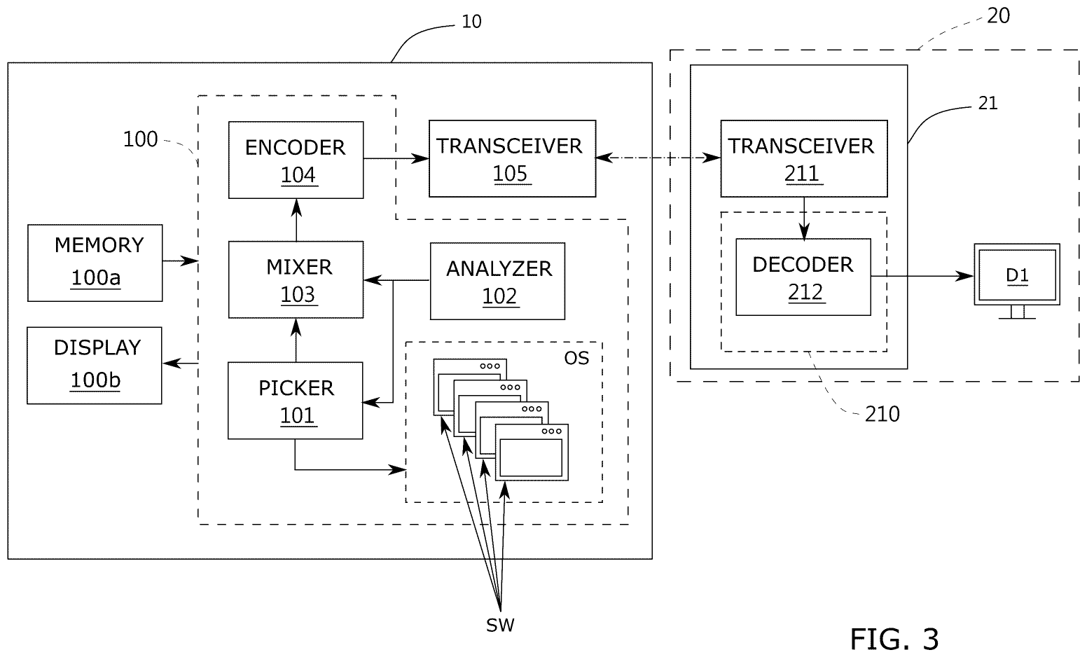

FIG. 3 illustrates a system block diagram of a content sharing system according to an embodiment of the present disclosure. The processing device 10 can be, for example, a computer, a laptop, mobile phone, a smart phone, a tablet, a PDA, etc. Such a device has non-volatile storage, processor, memory, display, networking interface, etc. The processing device 10 includes a processor 100, a memory 100a coupled to the processor 100, and a transceiver 105 coupled to the processor 100. A plurality of computer-executable instructions are stored in the memory 100a. The plurality of computer-executable instructions are configured to perform a method of sharing a presenting data including steps of: monitoring applications of the processing device 10; identifying contents of the applications having priority; generating presenting data of the contents; translating the presenting data to form a presenting signal; and transmitting the presenting signal to the presentation device 20, wherein the transceiver 105 coupled to the processor 100 is configured to transmit the presenting signal to the presentation device 20. The presentation device 20 can be, for example, a computer monitor, a television, a display panel, an all-in-one conferencing device, speaker device, a virtual reality headset, an augmented reality headset, a mixed reality headset, an audio headphone, a haptic feedback device, etc. or a combination thereof. The elements of the presenting data includes at least one of visual, auditory, haptic, device control data, metadata and other information or a combination thereof. In some embodiments, the applications includes any and/or all of applications running in the foreground and background of the operating system of the processing device 10. The contents further include any audio file, video file, content file received from other processing devices 10. The windows of the applications may or may not be displayed on a display 100b of the processing device 10. In some other embodiments, a communication application may be launched or running in the processing device. In further embodiments, the communication application is further configured to receive contents of applications from another processing device or applications of other processing devices. Presenting data of the contents may be a representation of a whole window resized and included in the display of the window of the communication application.

In some embodiments, as shown in FIG. 3, the plurality of computer-executable instructions are executed by modules of the processor 100. The modules of the processor 100 include a picker 101, an analyzer 102, a mixer 103, and an encoder 104. The picker 101 is configured to monitor applications SW running on the operating system OS of the processing device 10. In some embodiments, when a communication application is activated, at least a portion of the applications SW may be continuously monitored in the background of the communication application. The analyzer 102 is coupled to the picker 101. The analyzer 102 is configured to identify contents of the applications SW having priority. The mixer 103 is coupled to the picker 101 and analyzer 102. The mixer 103 is configured to take the presenting data of the contents identified to have priority and prepare the presenting data for encoding. The encoder 104 is coupled to the mixer 103. The encoder 104 is configured to translate the presenting data to a presenting signal. The transceiver 105 is coupled to the encoder 104 of the processor 100. The transceiver 105 is configured to transmit the presenting signal to the presentation device 20.

In some embodiments, a trigger marker is used by the analyzer 102 to identify contents of the applications having priority. The trigger marker includes at least one of an icon, metadata, audio data, a text, coordinates, and a pixel information. In further embodiments, the analyzer 102 may detect more than one trigger marker. A first trigger marker may be used to identify file content having priority and a second trigger marker may be used to identify media content having priority. The file content may include at least one of a specific window, a region of the screen, the full screen, a file (e.g. a PowerPoint file) or network collaborative content (e.g. file on OneDrive, Networked WhiteBoard application, . . . ). In further embodiments, the file content may further include at least one of media files that are pre-recorded and saved as a single file. Media files of the file content may be a video file, an audio file, or a combination of both. The media content may include a streaming video or representing image of users of the processing devices. In some embodiments, the media content may be a specific window, a region of the screen, or the full screen. In further embodiments, the media contents are contents that continuously change through time. In some other embodiments, such as in a communication application, a media file may further include content of a chat room, wherein data entered from a processing device is displayed as a media content. In some embodiments, the trigger marker may be the change in the participants motion, facial expression, audio source from. In the event where there is a lack of trigger marker or a trigger marker is no longer detected, the content associated with the trigger marker may be removed from the presenting signal.

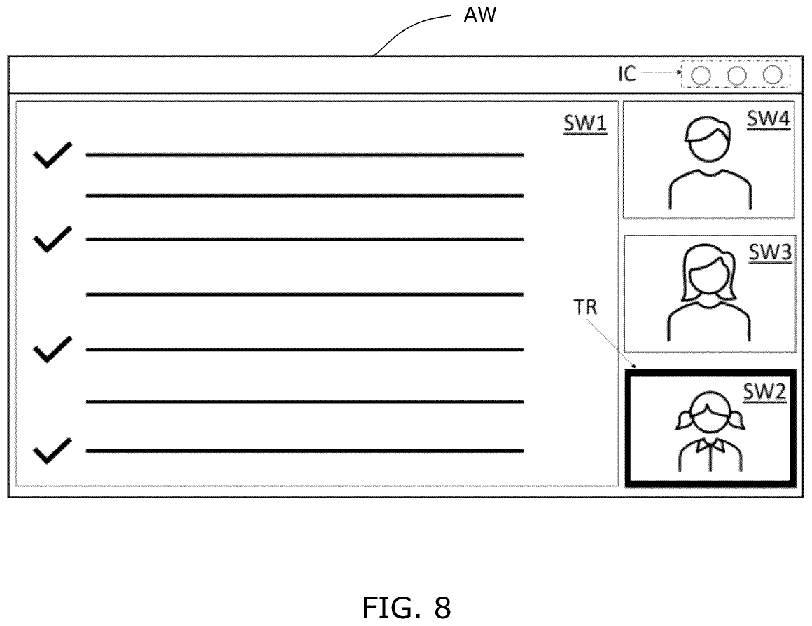

FIG. 8 illustrates that a communication application AW of the processing device 10a is activated according to an embodiment of the present disclosure. A first content SW1 may be a file content displayed in a sub-window of the communication application. A plurality of second content SW2, SW3, and SW4 may be media contents displayed in sub-windows of the communication application. The first content SW1 and the second content SW2 of the communication application AW may have priority and are to be detected by the content sharing system 1. During operation, a portion of the communication application AW may be assigned by the content sharing system as a reference marker IC. The reference marker IC may be at least one icon affixed on the communication application AW. In the exemplary embodiment shown in FIG. 8, the reference marker IC includes three icons affixed to a corner of the communication application AW. Presenting data of the contents are displayed in the communication application AW in a grid-based layout. And, the reference marker IC is used to track the presenting data of the contents including the second contents SW2, SW3, and SW4. The second content SW2 having priority is identified according to a relation between the reference marker IC and the trigger marker TR on the communication application AW. The reference marker may be set as a reference point for determining the coordinate position of the trigger marker on the window of the communication application. In an exemplary embodiment, as shown in FIG. 8, the trigger marker TR may be an enclosure surrounding the second content SW2. Thus, the position of the trigger marker TR in the window provides the positioning coordinate of the second content SW2 in the window. Further, the reference marker IC is further configured to determine an event such as starting the communication application (i.e. online meeting).

In some embodiments, positions of the images on the grid-based layout changes according to a size of the window of the communication application, a number of presenting data of contents displayed on the application window, or a shape of the application window. Position or coordinate of the reference marker on the window of the communication application remain relatively the same.

In some embodiments, the analyzer 102 determines an application identifier that is used to relate a monitored application on the processing device to an application programming interface. The analyzer 102 employs the related application programming interface to determine related application contents. The application programming interfaces can communicate directly with the monitored application on the processing device using a local application program interface (API), employing a remote API for cloud-enabled applications, or employing other communication means appreciated by a person skilled in the art. In some embodiments, the related application contents priority is determined by relating metadata information that is determined through the application programming interface. In some embodiments, the related application contents priority is determined by a classifier algorithm.

In some embodiments, with reference to FIG. 1A, the presentation device 20 may further be coupled to a base unit 21 that include a base node 30. In some embodiments, with reference to FIG. 1C, the presentation device 20 may further include a base node 30 built into the presentation device 20. The presentation device 20 may serve as a base node of the content sharing system 1. In some other embodiments, as shown in FIG. 1D, the base node 30 may be located in a cloud server having a network connection with the presentation device 20 and the processing devices 10a, 10b and 10c. In some further embodiments, as shown in FIG. 1A, the presentation device 20 includes a display unit DI and a base unit 21 coupled to the display unit D1. The base unit 21 serves as the base node of the presentation device 20.

The base node is configured to receive the presenting signal and convert a plurality of element data of the presenting signal to unit data. In an exemplary embodiment, the presenting signal may be converted to an image displayed on the display unit D1. As shown in FIG. 3, The base node includes a transceiver 211 and a decoder 212 electrically coupled to the display unit D1. In some embodiments, the decoder 212 is further configured to edit the images to be displayed on the display unit D1. The editing of the images may be performed automatically. The transceiver 211 is configured to receive the presenting signal from the processing device 10 through the network. The decoder 212 is configured to receive the presenting signal from the transceiver 211 and decode the presenting signal to a format that can be displayed on the display unit D1.

In some other embodiments, a communication application may be launched or running in the processing device. In further embodiments, the communication application is further configured to receive contents of applications from another processing device or applications of other processing devices. Presenting data of the contents may be a representation of a whole window resized and included in the display of the window of the communication application.

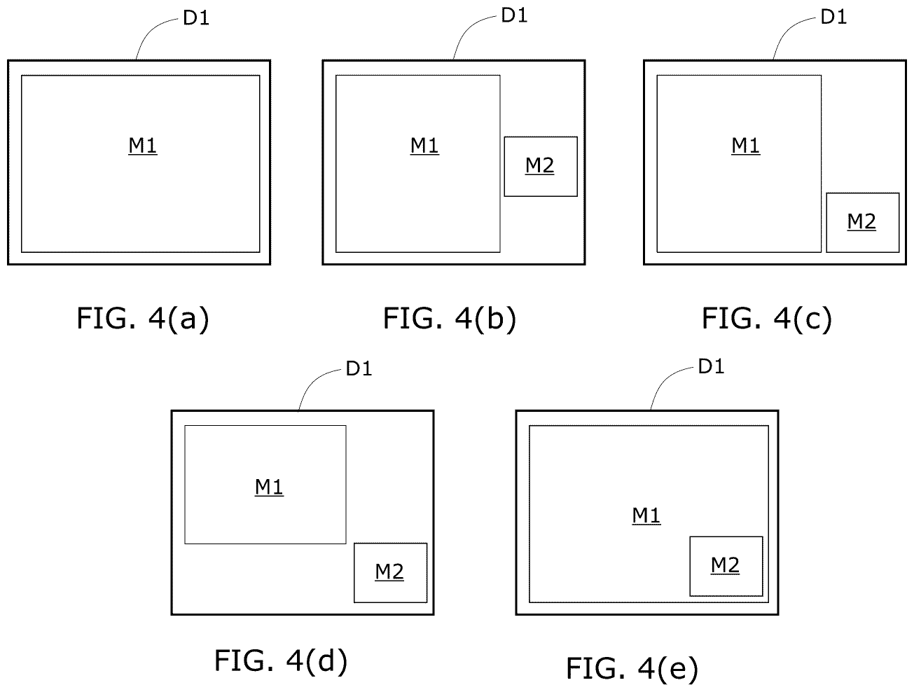

FIGS. 4(a) to 4(e) illustrate five different display image arrangements according to embodiments of the present disclosure. In some embodiments, the display unit D1 is configured to receive one presenting image when only one content of the communication application has priority. FIG. 4(a) illustrates the display unit D1 displaying a decoded first image M1. In some embodiments, the first image M1 corresponds to the first content SW1 in FIG. 8. In some other embodiments, the first image M1 corresponds to any one of the second content SW2, SW3, and SW4 in FIG. 8. In other words, the first image M1 is configured to display image of a content that has highest priority or only priority. FIGS. 4(b) and 4(c) illustrate the display unit D1 displaying a decoded first image M1 and second image M2. In some embodiments, the first image M1 corresponds to the first content SW1 in FIG. 8 and the second image M2 corresponds to any one of the second contents SW2, SW3, and SW4 in FIG. 8. In some other embodiments, the first image MI corresponds to any one of the second contents SW2, SW3, and SW4 in FIG. 8 and the second image M2 corresponds to the first content SW1 in FIG. 8. As shown in FIGS. 4(b) and 4(c), the first image M1 may be the image of the sub-window having higher priority and the second image M2 may be the image of the content having lower priority. Thus, the content having lower priority has image displayed on a smaller scale compared to the content having higher priority. In the same way as FIGS. 4(b) and 4(c), FIGS. 4(d) and 4(e) shows the second image M2 on a smaller scale compared to the first image. However, as shown in FIGS. 4(d) and 4(e), the aspect ratio of the original images from the processing device is maintained. In some other embodiment, the size of the second image M2 May vary through time depending on activity shown in the client window. In further embodiments, the presenting signal further includes metadata configured to determine sizing of the displayed images. Editing of the displayed images includes at least, manipulation of aspect ratio, cropping, watermarking, alpha blending, or editing of the content. Further, editing of the content may include combining of a plurality of images, icons, text through superimposing, merging, etc. The metadata includes information corresponding to the type of content included in the images to determine the sizing of the images on the display. In further embodiments, the sizing of the images may be assigned by the user of the processing device. In further embodiments, the processing device assigns the sizing of the display images before being transmitted to the presentation device. The processing device may determine the sizing of the display images according to the type of the contents. In further embodiments, the base node may be configured to analyze the images received by the base node and determine the type of the contents corresponding to the images. And, the sizing of the display images is determined according to the type of contents. And, the sizing of the display images is determined according to the type of the contents.

In some embodiments, the mixer 103 determines the arrangement as illustrated in FIGS. 4(a) to 4(e) and the determination may be based on the application contents of the applications having priority, the display unit arrangement, the display unit context, the user context, the local or remote context of the communication session, the physical environment, business logic rules, conversational rules, preferences or a combination thereof. The determination from the mixer 103 is further encoded to the presenting signal by the encoder 105. Further, the transceiver 105 transmits the presenting signal to the transceiver 211 of the presentation device 20.

In some other embodiments, the decoder 212 of the presentation device 20 decodes the received presenting signal. The decoder 212 determines the arrangement as illustrated in FIGS. 4(a) to 4(e) and the determination may be based on the application contents of the applications having priority, the display unit arrangement, the display unit context, the user context, the local or remote context of the communication session, the physical environment, business logic rules, conversational rules, preferences or a combination thereof.

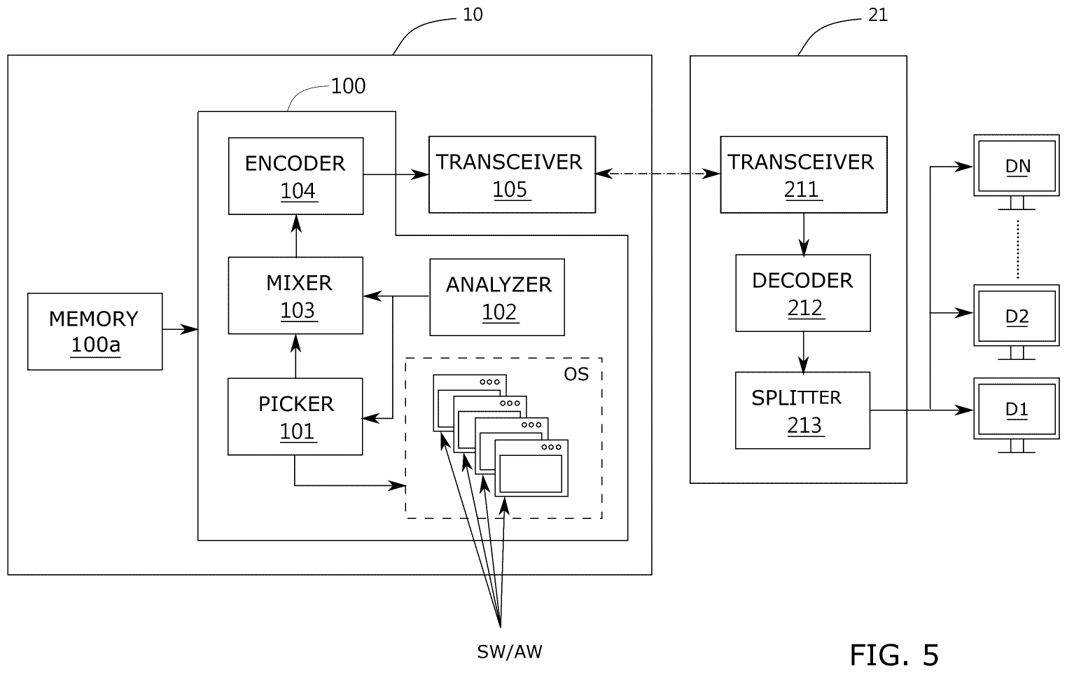

FIG. 5 illustrates a system block diagram of a content sharing system according to another embodiment of the present disclosure. The processing device 10 can be, for example, a computer, a laptop, mobile phone, a smart phone, a tablet, a PDA, etc. Such a device has non-volatile storage, processor, memory, display, networking interface, etc. The processing device 10 includes a processor 100, a memory 100a coupled to the processor 100, and a transceiver 105 coupled to the processor 100. A plurality of computer-executable instructions are stored in the memory 100a. The plurality of computer-executable instructions are configured to perform a method of sharing a presenting data including steps of: monitoring applications of the processing device 10; identifying a contents of the applications having priority; generating presenting data of the contents; translating the presenting data to form a presenting signal; and transmitting the presenting signal to the display units D1, D2, . . . . DN, wherein the transceiver 105 coupled to the processor 100 is configured to transmit the presenting signal to the display units D1, D2, . . . . DN. In some embodiments, the contents may or may not be displayed on the display of the processing device.

In some embodiments, the plurality of computer-executable instructions are executed by modules of the processor 100. The modules of the processor 100 include a picker 101, an analyzer 102, a mixer 103, and an encoder 104. The picker 101 is configured to monitor sub-windows SW running on the operating system OS of the processing device 10. In some embodiments, when a communication application is activated, contents may be continuously being received and monitored by the communication application. However, in some embodiments, a portion of the contents received from processing devices are not displayed on the application window. The analyzer 102 is coupled to the picker 101. The analyzer 102 configured to identify contents SW of the communication application having priority. The mixer 103 is coupled to the picker 101 and the analyzer 102 and configured to take the presenting data of the contents SW identified to have priority and prepare the presenting data for encoding. The encoder 104 is coupled to the mixer 103 and configured to translate the presenting data to a presenting signal. In some embodiments, when generating the presenting signal, the data regarding the sizing of the presenting data is already included within the presenting signal. The transceiver 105 is coupled to the encoder 104 of the processor 100 and configured to transmit the presenting signal to the display units D1, D2, . . . . DN.

In some embodiments, a trigger marker is used by the analyzer 102 to identify contents SW having priority. The trigger marker includes at least one of an icon, metadata, audio data, a text, coordinates, and a pixel information. In further embodiments, the analyzer 102 may detect more than one trigger marker. A first trigger marker may be used to identify file content having priority and a second trigger marker may be used to identify media content. The file content may include at least one of a specific window, a region of the screen, the full screen, a file (e.g. a PowerPoint file) or network collaborative content (e.g. file on OneDrive, Networked WhiteBoard application, . . . ). The media content may include a streaming video or representation image of users of the processing devices. In some embodiments, the media content may be a specific window, a region of the screen, or the full screen. Further, the media content may be a dynamic content. In some embodiments, the trigger marker is the change in the participants motion, facial expression, audio source.

FIG. 8 illustrates that a communication application AW of the processing device 10a is activated according to an embodiment of the present disclosure. In an exemplary embodiment, the communication application AW may be a communication application 1. A first content SW1 may be a file content. A plurality of second contents SW2, SW3, and SW4 may be media contents of processing devices linked to the communication application. The first content SW1 and the second content SW2 of the communication application AW may have priority and are to be detected by the content sharing system 1. During operation, a portion of the communication application AW may be assigned as a reference marker IC. The reference marker IC may be at least one icon affixed on the communication application AW. In the exemplary embodiment shown in FIG. 8, the reference marker IC includes three icons affixed to a corner of the communication application AW. Presenting data of the contents are displayed in the communication application AW in a grid-based layout. And, the reference marker IC is used to track the presenting data of the contents including the second contents SW2, SW3, and SW4. The second content SW2 having priority is identified according to a relation between the reference marker IC and the trigger marker TR on the communication application AW. In an exemplary embodiment as shown in FIG. 8, the trigger marker TR may be an enclosure surrounding the second content SW2. Further, the reference marker IC is further configured to determine an event such as starting the communication application (i.e. online meeting). In some other embodiments, a communication application may be launched or running in the processing device. In further embodiments, the communication application is further configured to receive contents of applications from another processing device or applications of other processing devices. Presenting data of the contents may be a representation of a whole window resized and included in the display of the window of the communication application.

In some embodiments, positions of the images on the grid-based layout changes according to a size of the window of the communication application, a number of sub-windows on display on the application window, or a shape of the application window. Position of the reference marker on the communication application remain the same.

In some embodiments, the base node 30 coupled to a plurality of display units D1, D2, . . . . DN is configured to receive the presenting signal and convert the presenting signal to a plurality of images displayed on the display units D1, D2, . . . . DN. As shown in FIG. 5, The base node 30 includes a transceiver 211, a decoder 212 coupled to the transceiver 211, and a splitter 213 electrically coupled to the decoder 212 and the display units D1, D2, . . . . DN. The transceiver 211 is configured to receive the presenting signal from the processing device 10 through the network. The decoder 212 is configured to receive the presenting signal from the transceiver 211 and decode presenting signal to a file format that can be read by the splitter 213. The splitter 213 is configured to determine the number of display units D1, D2, . . . . DN to which the decode presenting signal is to be displayed to. Further, the splitter 213 is configured to determine number of images included in the presenting signal. In some embodiments, the presenting signal includes only one image and can be divided into a plurality of display units D1, D2, . . . . DN. In some other embodiments, the presenting signal includes a plurality of images and can be correspondingly displayed to a plurality of display units D1, D2, . . . . DN.

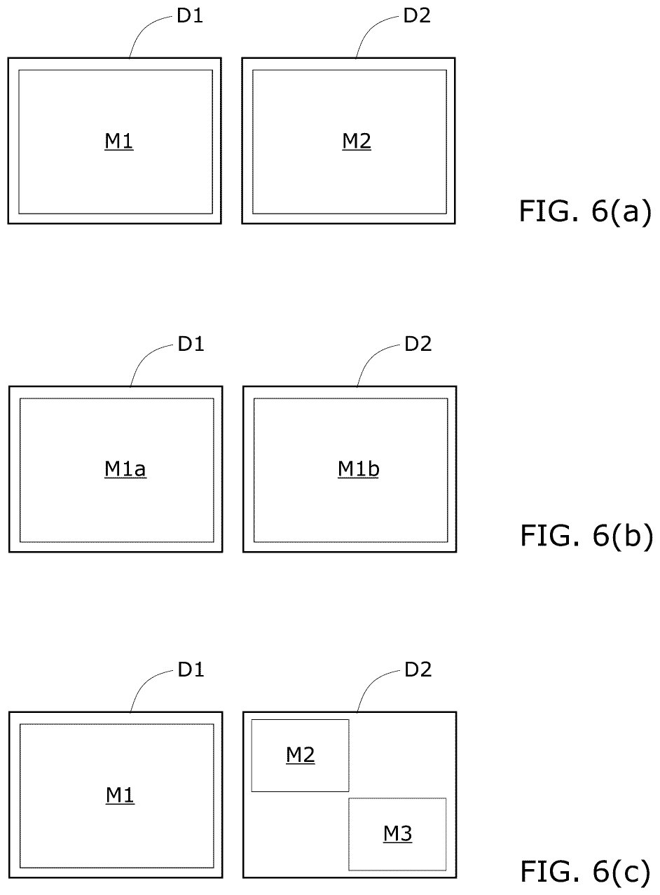

FIGS. 6(a) to 6(c) illustrate that three different display image arrangements according to other embodiments of the present disclosure. In some embodiments, the display unit D1 is configured to receive image of the first content of the communication application having priority and the display unit D2 is configured to receive image of the second content of the communication application having priority. FIG. 6(a) illustrates the display unit D1 displaying a decoded first image M1 and the display unit D2 displaying a decoded second image M2. In some other embodiments, when only one content has priority, the image of the content is divided and displayed on the display unit D1 and display unit D2. FIG. 6(b) illustrates the display unit D1 displaying a decoded first image portion M1a and the display unit D2 displaying a decoded second image portion M1b. FIG. 6(c) illustrates the display unit D1 displaying a decoded first image M1 and the display unit D2 displaying a decoded second image M2 and third image M3. In other embodiments, the decoded second image M2 and the third image M3 displayed on the display unit D2 may be in different arrangements. The different arrangements of the decoded second image M2 and the third image M3 may refer to the different arrangements of the first image M1 and second image M2 of the display unit D1 as shown in FIGS. 4(b) to 4(e).

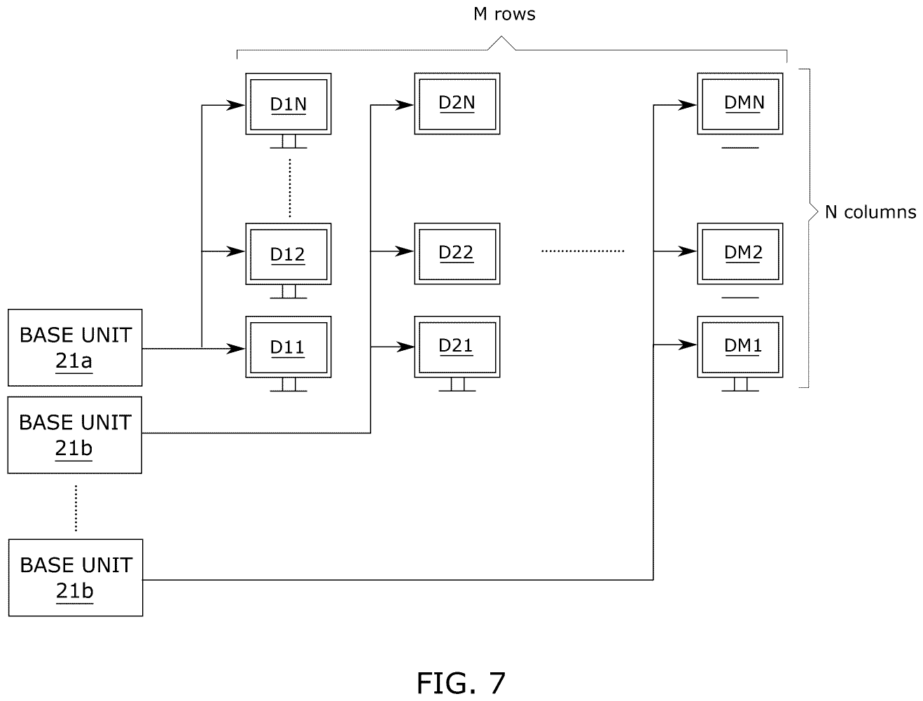

In some embodiments, as shown in FIG. 7, the content sharing system has M base unit 21a, 21b and M rows of presentation devices. Each row of presentation devices has N presentation devices, so the content sharing system has M*N presentation devices. After a paired process of the base units 21a, 21b is finished, one of the base unit 21a is assigned to be a master base unit 21a and others are assigned to be slave base units 21b. The master base unit 21a can be further electrically coupled to one row of display units D11 to DIN, and each slave base unit 21b can be further paired to the corresponding row of display units D21 to D2N, ˜DM1 to DMN. With further reference to FIG. 5, each of the base units 21a, 21b includes a transceiver 211 a decoder 212, and a splitter 213 electrically coupled to the corresponding display unit D11 to DMN. Using the master base unit 21a as an example, the transceiver 211 of the master base unit 21a is configured to receive the presenting signal from the processing device 10 through the network with the coordinating with paired master base unit 21a. The decoder 212 of the master base unit 21a is configured to receive the presenting signal and decode presenting signal to a file format that can be read by the splitter 213 of the master base unit 21a. The splitter 213 of the master base unit 21a is configured to determine the number of the N display units D11, D12, . . . . D1N to which the decode presenting signal is to be displayed to. Further, the splitter 213 is configured to determine number of images included in the presenting signal. In some embodiments, the presenting signal includes only one image and can be divided into a plurality of display units D11, D12, . . . . D1N. In some other embodiments, the presenting signal includes a plurality of images and can be correspondingly displayed to a plurality of display units D11, D12, . . . . D1N.

In some embodiments, the mixer 103 determines the arrangement as illustrated in FIGS. 6(a) to 6(c) and FIG. 7. The determination may be based the application contents of the applications having priority, the display unit arrangement, the display unit context, the user context, the local or remote context of the communication session, the physical environment, business logic rules, conversational rules, preferences or a combination thereof. In further embodiments, the decoder 212 determines the arrangement as illustrated in FIGS. 6(a) to 6(c) and FIG. 7. The determination may be based on the application contents of the applications having priority, the display unit arrangement, the display unit context, the user context, the local or remote context of the communication session, the physical environment, business logic rules, conversational rules, preferences or a combination thereof.

In some embodiments, the transceiver 211 receives presenting signals from multiple sources and the decoder 212 determines the arrangement based on a combination of the presenting signals, the display unit's arrangement, the local or remote context of the communication session, the room context, business logic rules, conversational rules, preferences or a combination thereof.

In some embodiments, the content sharing system as shown in FIG. 7 has an arbitrary number of presentation devices per base node.

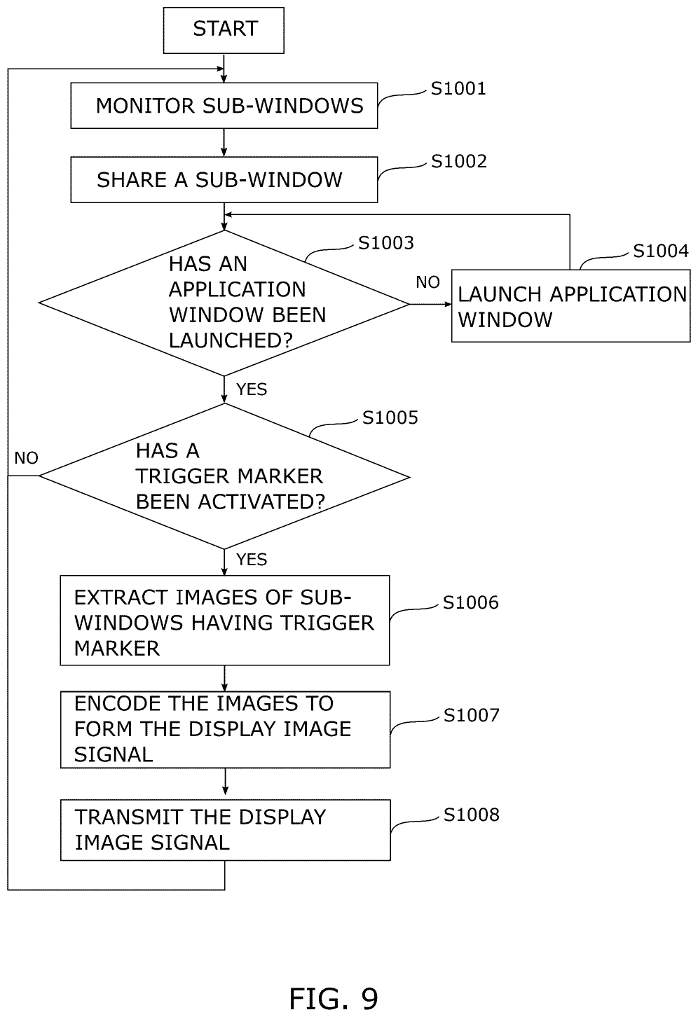

FIG. 9 illustrates a flowchart of the operation of the processing device according to an embodiment of the present disclosure. In some embodiments, the content sharing system can be running in the background of the operating system of the processing device. In S1001, the content sharing system is monitoring the applications running in the operating system. In S1002, the content sharing system shares an image of a content to a presentation device. In an exemplary embodiment, the image shared may be presenting image of the content SW1 in FIG. 8. In S1003, the content sharing system determines whether a communication application has been launched. In some other embodiments, when a communication application is already launched, the content sharing system is determining whether to share the content to the presentation device. When the communication application has not been launched, the content sharing system may prompt a user to launch the communication application through a message window or icon or the like, as shown in S1004. In some other embodiments, the user may be prompted to share the content to the communication application. When the communication application is launched, in S1005, the content sharing system determines whether there is a content that has received priority by detecting the trigger marker. In some embodiments, the content being monitored for trigger marker may be a media content. The priority of the content can be further determined using the trigger marker. That is, the trigger marker corresponding to the first content and the second content are compared and used to determine priorities of the first content and the second content. In some embodiments, only one content receives priority. In some other embodiment, a plurality of the contents receive priority simultaneously. In S1006, presenting image of the content having priority is generated. In S1007, the presenting image is converted to a presenting signal by encoding the image. When there is a plurality of presenting data to be transmitted, the images can be combined to form a composite image data. The method of forming the composite image date includes alpha blending. In some other embodiments, the plurality of images are placed sequentially or pipeline method to form image data for transmission. And, in S1008, the presenting signal is transmitted to the presentation device. In some embodiments, the presenting signal is transmitted to presentation device. In some embodiments, the presenting signal is transmitted to presentation device through the base unit. The presenting signal may be transmitted through a wired or wireless network.

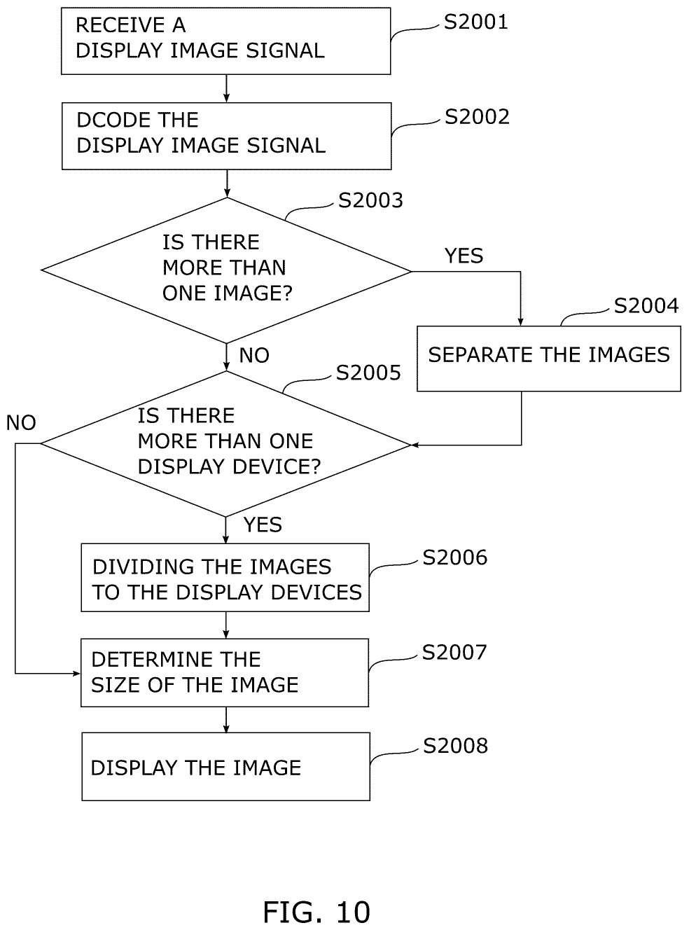

FIG. 10 illustrates a flowchart of the operation of the base node according to an embodiment of the present disclosure. In S2001, the base node receives the presenting signal. In S2002, the presenting signal is decoded. In S2003, it is determined if there are more than one image included in the presenting signal. When there is more than one image in the presenting signal, in S2004, the images are separated from each other. In S2005, the number of presentation devices to be used to display the content of the presenting signal. In some embodiments, only one presentation device is available for display. In some other embodiment, there are more presentation devices available than needed to display the images. In some other embodiments, all of the presentation devices are utilized to display images. In S2007, the size and/or resolution of the images are determined as described in FIGS. 4(a) to 4(e). In addition, the images on the presentation device are sized according to the priorities of the first content and the second sub-window. When there is more than one presentation device to be used, in S2006, the designation of the images are determined as described in FIGS. 6(a) to 6(c). In S2008, the images are correspondingly displayed.

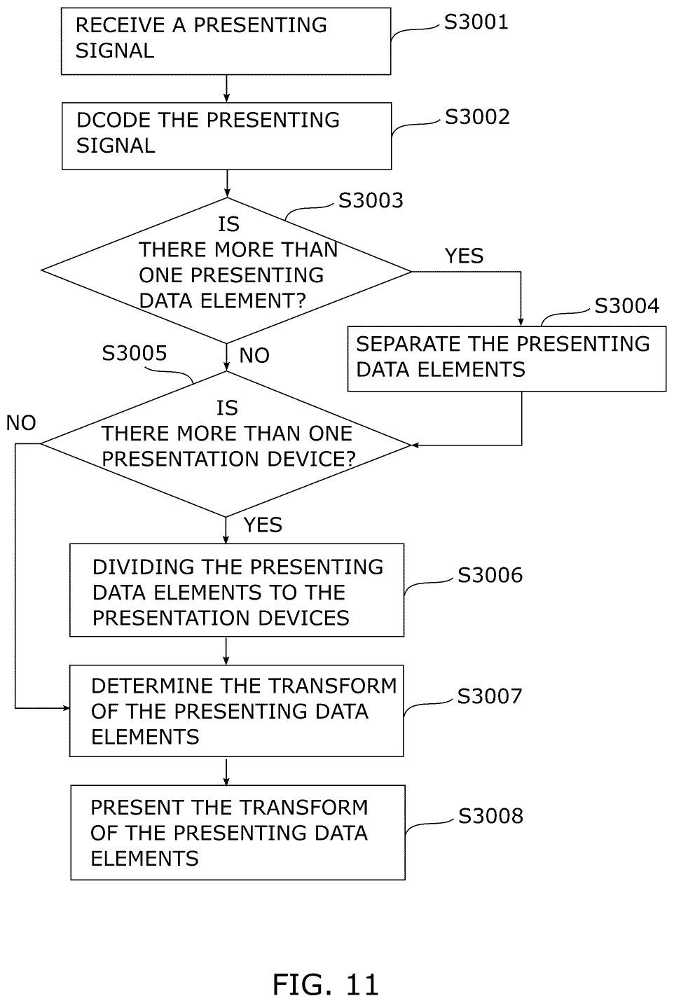

FIG. 11 illustrates a flowchart of the operation of the base node according to an embodiment of the present disclosure. In S3001, the base node receives the presenting signal. In S3002, the presenting signal is decoded. In S3003, it is determined if there are more than one presenting data element included in the presenting signal. Presenting data elements may represent data such as visual data, audio data, haptic data, device control data, metadata, etc. When there is more than one presenting data element in the presenting signal, in S3004, the presenting data elements are separated from each other. In S3005, the number of presentation devices to be used to present the contents of the presenting signal in considered. In some embodiments, only one presentation device is available for presenting. In some other embodiment, there are more presentation devices available than needed to display the content. In some other embodiments, all of the presentation devices are utilized to display contents. In S3007, the transform of the presenting data elements is determined. For image data, this may include the size, resolution and other image enhancements or adaptations of the images. For audio data, this may include the sampling rate, noise reduction and audio enhancements or audio adaptations of the audio data. The transform may depend and be adapted towards the capabilities of the related presentation device and the context wherein the users, systems and devices operate and/or the type, contents, priorities of the presenting data element. The transform may depend and be adapted according to the priorities of the presenting data elements. When there is more than one presentation device to be used, in S3006, the presenting data elements are divided to the presentation devices. The dividing may assign a presenting data element to a single presentation device or assign a presenting data element to multiple presentation devices. The dividing may depend and be adapted towards the capabilities of the related presentation devices, the context wherein the users, systems and devices operate and/or the type, contents, priorities of the presenting data elements. In S3008, the presenting data elements are transformed and presented.

Accordingly, one aspect of the present disclosure provides a system configured to share presenting data between a presentation device and a processing device. The system includes a processor, a memory, and the transceiver. The memory is coupled to the processor, wherein computer-executable instructions are loaded, the plurality of computer-executable instructions performing a method comprising: monitoring applications of the processing device; identifying contents of the applications having priority; generating the presenting data of the contents; translating the presenting data to form a presenting signal; and transmitting the presenting signal to a base node connected to the presentation device. The transceiver is coupled to the processor configured to transmit the presenting signal to the presentation device.

In some embodiments, the applications include a communication application, and the communication application is configured to receive contents of applications from another processing device.

In some embodiments, the method further comprises: identifying a reference marker corresponding to the applications; and identifying a trigger marker corresponding to the contents.

In some embodiments, the reference marker includes at least one of an icon, metadata, audio data, a text, coordinates, and a pixel information; and the trigger marker includes at least one of an icon, metadata, audio data, a text, coordinates, and a pixel information.

In some embodiments, the reference marker is further configured to determine an event of the applications.

In some embodiments, the contents having priority is identified according to a relation between the reference marker and the trigger marker.

In some embodiments, the method further comprises: identifying a trigger marker corresponding to the contents, wherein the trigger marker includes at least one of an icon, metadata, audio data, a text, coordinates, and a pixel information.

In some embodiments, the system further comprises a base unit as the base node connected to the presentation device and configured to receive the presenting signal from the processing device.

In some embodiments, the system further comprises a peripheral device electrically coupled to the processing device and paired with the base unit, wherein the presenting signal is transmitted between the peripheral device and the base unit.

In some embodiments, the base unit is configured to transmit the presenting signal to the presentation device and another presentation device.

In some embodiments, the method further comprises extracting, by the base node, a plurality of element data from the presenting signal; combining, by the base node, the plurality of element data to form a unit data; and providing, by the base node, the unit data to the presentation device.

In some embodiments, the plurality of element data are image data; the unit data is a display image; and providing the unit data to the presentation device includes displaying the display image on a display unit of the presentation device.

In some embodiments, the method further comprises: separating, by the base node, a plurality of element data from the presenting signal; providing, by the base node, the plurality of element data on the presentation device; and editing, by the base node, the plurality of element data provided to the presentation device.

In some embodiments, the method further comprises combining, by the base node, the plurality of element data to form a unit data.

In some embodiments, the method further comprises: comparing the contents having priority and determining priority levels of the contents, wherein the plurality of element data are edited according to the priority levels of the contents.

In some embodiments, the plurality of element data are image data.

In some embodiments, the presenting signal includes metadata configured to identify types of the contents.

Accordingly, another aspect of the present disclosure provides a method for sharing a display image. The method comprises: monitoring applications of the processing device; identifying contents of the applications having priority; generating presenting data of the contents; translating the presenting data to form a presenting signal; and transmitting the presenting signal to a base node connected to the presentation device.

In some embodiments, the applications include a communication application, and the communication application is configured to receive contents of applications from another processing device.

In some embodiments, the method further comprises: identifying a reference marker corresponding to the applications; and identifying a trigger marker corresponding to the contents.

In some embodiments, the reference marker includes at least one of an icon, metadata, audio data, a text, coordinates, and a pixel information; and the trigger marker includes at least one of an icon, metadata, audio data, a text, coordinates, and a pixel information.

In some embodiments, the reference marker is further configured to determine an event of the applications.

In some embodiments, the content having priority is identified according to a relation between the reference marker and the trigger marker.

In some embodiments, the method further comprises identifying a trigger marker corresponding to the contents, wherein the trigger marker includes at least one of an icon, metadata, audio data, a text, coordinates, and a pixel information.

In some embodiments, the method further comprises transmitting the presenting signal between the processing device and a base unit connected to the presentation device as the base node.

In some embodiments, the method further comprises transmitting the presenting signal between a peripheral device coupled to the processing device and the base unit.

In some embodiments, the base unit is configured to transmit the presenting data to the presentation device and another presentation device.

In some embodiments, the method further comprises: extracting, by the base node, a plurality of element data from the presenting signal; combining, by the base node, the plurality of element data to form a unit data; and providing, by the base node, the unit data to the presentation device.

In some embodiments, the plurality of element data are image data; the unit data is a display image; and providing the unit data to the presentation device includes displaying the display image on a display unit of the presentation device.

In some embodiments, the method further comprises: separating, by the base node, a plurality of element data from the presenting signal; providing, by the base node, the plurality of element data on the presentation device; and editing, by the base node, the plurality of element data provided to the presentation device.

In some embodiments, the method further comprising combining the plurality of element data to form a unit data.

In some embodiments, the method further comprises: comparing the contents having priority and determining priority levels of the contents, wherein the plurality of element data are edited according to the priority levels of the contents.

In some embodiments, the plurality of element data are image data.

In some embodiments, the presenting signal includes an identifier configured to identify types of the contents.

Accordingly, another aspect of the present disclosure provides a method for sharing a presenting data. The method comprises: monitoring priorities of contents of a communications application, wherein the contents include contents of applications of processing devices linked through the communication application; generating the presenting data of contents having priority; translating the presenting data to form a presenting signal; and transmitting the presenting signal to a presentation device.

In some embodiments, the method further comprises monitoring a trigger marker to determine the contents having priority, wherein the trigger marker includes at least one of an icon, metadata, audio data, a text, coordinates, and a pixel information.

In some embodiments, the content having priority includes a first content and a second content, wherein the first content and the second content are of different types of content.

In some embodiments, the presenting signal further includes an identifier configured to differentiate the first content and the second content.

In some embodiments, the method further comprises: identifying a reference marker on the communication application; and identifying a trigger marker of the second content.

In some embodiments, the reference marker includes at least one of an icon, metadata, audio data, a text, coordinates, and a pixel information; and the trigger marker includes at least one of an icon, metadata, audio data, a text, coordinates, and a pixel information.

In some embodiments, the reference marker is further configured to determine an event of the communication application.

In some embodiments, the element data of the first content and the second content are included in a display window of the communication application.

In some embodiments, the element data is an image data size, shape, and position of the element data of the second content are configured to change in the display window; and position of the reference marker on the display window remain the same.

In some embodiments, the second content is identified according to a relation between the reference marker and the trigger marker on the display window.

In some embodiments, the presenting signal is transmitted to the presentation device through a base unit coupled to the presentation device.

In some embodiments, the presenting signal is transmitted to the base unit through a peripheral device.

In some embodiments, the method further comprises: extracting, by the base unit, a plurality of element data from the presenting signal; and transmitting the plurality of element data correspondingly to the presentation device and another presentation device coupled to the base unit.

In some embodiments, the plurality of element data are image data.

In some embodiments, the presenting signal includes a composite image file of the presenting data of the contents.

Accordingly, another aspect of the present disclosure provides a method for sharing a presenting data. The method comprises: connecting a content sharing system of a processing device to a communication application; monitoring, by the content sharing system, contents of the communication application; determining, by the content sharing system, priorities of the contents; encoding, by the content sharing system, element data of at least one of the contents having priority to form the presenting data; translating, by the content sharing system, the presenting data to form a presenting signal; and transmitting, by the content sharing system, the presenting signal to a presentation device.

In some embodiments, the contents include at least of a media content and a file content; the file content including at least one of a specific application window, a region of the screen, a full screen, a file, and a network collaborative content; the media content including a streaming video of users of the communication application.

In some embodiments, the method further comprises combining, by a base node corresponding to the presentation device, the element data of the contents included in the presenting data.

In some embodiments, the method further comprises combining, by the content sharing system, the element data of the contents to form the presenting data.

In some embodiments, the method further comprises monitoring, by the content sharing system, a reference marker and a trigger marker, wherein the reference marker is configured to indicate an event of the communication window, wherein the trigger marker is configured to indicate the contents having priority.

In some embodiments, the reference marker includes at least one of an icon, metadata, audio data, a text, coordinates, and a pixel information; and the trigger marker includes at least one of an icon, metadata, audio data, a text, coordinates, and a pixel information.

In some embodiments, the method further comprises: separating, by a base node corresponding to the presentation device, the presenting data to a plurality of sub-element data; and transmitting, by the base node, the plurality of sub-element data correspondingly to display units of the presentation device, wherein each of the plurality of sub-element data corresponds to one content.

In some embodiments, the method further comprises: separating, by a base node corresponding to the presentation device, the presenting data of one content to a plurality of sub-element data; and transmitting, by the base node, the sub-element data correspondingly to display units of the presentation device.

In some embodiments, the sub-element data include image data.

In some embodiments, the element data includes image data.

Those skilled in the art will readily observe that numerous modifications and alterations of the device and method may be made while retaining the teachings of the invention. Accordingly, the above disclosure should be construed as limited only by the metes and bounds of the appended claims.

1-59. (canceled)

60. A system configured to share presenting data between a presentation device and a processing device, comprising:
a processor;
a memory coupled to the processor, wherein computer-executable instructions are loaded, the plurality of computer-executable instructions performing a method comprising:
monitoring applications of the processing device;
identifying contents of the applications having priority;
generating the presenting data of the contents;
translating the presenting data to form a presenting signal; and
transmitting the presenting signal to a base node connected to the presentation device; and
a transceiver coupled to the processor configured to transmit the presenting signal to the presentation device.

61. The system of claim 60, wherein the applications include a communication application, and the communication application is configured to receive contents of applications from another processing device.

62. The system of claim 60, wherein the method further comprises:
identifying a reference marker corresponding to the applications; and
identifying a trigger marker corresponding to the contents.

63. The system of claim 62, wherein the reference marker includes at least one of an icon, metadata, audio data, a text, coordinates, and a pixel information; and the trigger marker includes at least one of an icon, metadata, audio data, a text, coordinates, and a pixel information, or
wherein the reference marker is further configured to determine an event of the applications, or
wherein the content having priority is identified according to a relation between the reference marker and the trigger marker.

64. The system of claim 60, wherein the method further comprising:
identifying a trigger marker corresponding to the contents;
wherein the trigger marker includes at least one of an icon, metadata, audio data, a text, coordinates, and a pixel information.

65. The system of claim 60, further comprising:
a base unit as the base node connected to the presentation device and configured to receive the presenting signal from the processing device.

66. The system of claim 65, further comprising:
a peripheral device electrically coupled to the processing device and paired with the base unit; and wherein the presenting signal is transmitted between the peripheral device and the base unit, or
wherein the base unit is configured to transmit the presenting signal to the presentation device and another presentation device.

67. The system of claim 60, wherein the method further comprises:
extracting, by the base node, a plurality of element data from the presenting signal;
combining, by the base node, the plurality of element data to form a unit data; and
providing, by the base node, the unit data to the presentation device.

68. The system of claim 67, wherein:
the plurality of element data is image data;
the unit data is a display image; and
providing the unit data to the presentation device includes displaying the display image on a display unit of the presentation device.

69. The system of claim 60, wherein the method further comprises:
separating, by the base node, a plurality of element data from the presenting signal;
providing, by the base node, the plurality of element data on the presentation device; and
editing, by the base node, the plurality of element data provided to the presentation device.

70. The system of claim 69, wherein the method further comprises:
combining, by the base node, the plurality of element data to form a unit data, or
comparing the contents having priority; determining priority levels of the contents; and, wherein the plurality of element data are edited according to the priority levels of the contents.

71. The system of claim 60, wherein the presenting signal includes metadata configured to identify types of the contents.

72. A method for sharing a display image, comprising:
monitoring applications of the processing device;
identifying contents of the applications having priority;
generating presenting data of the contents;
translating the presenting data to form a presenting signal; and
transmitting the presenting signal to a base node connected to the presentation device.

73. The method of claim 72, wherein the applications include a communication application, and the communication application is configured to receive contents of applications from another processing device.

74. The method of claim 73, further comprising:
identifying a reference marker corresponding to the applications; and
identifying a trigger marker corresponding to the contents.

75. The method of claim 72, further comprising:
transmitting the presenting signal between the processing device and a base unit connected to the presentation device as the base node.

76. The method of claim 75, further comprising:
transmitting the presenting signal between a peripheral device coupled to the processing device and the base unit, or
wherein the base unit is configured to transmit the presenting data to the presentation device and another presentation device.

77. The method of claim 72, further comprising:
extracting, by the base node, a plurality of element data from the presenting signal;
combining, by the base node, the plurality of element data to form a unit data; and
providing, by the base node, the unit data to the presentation device.

78. The method of claim 72, wherein the presenting signal includes an identifier configured to identify types of the contents.

79. A method for sharing a presenting data, comprising:
monitoring priorities of contents of a communications application, wherein the contents include contents of applications of processing devices linked through the communication application;
generating the presenting data of contents having priority;
translating the presenting data to form a presenting signal; and
transmitting the presenting signal to a presentation device.

80. The method of claim 79, further comprising:
monitoring a trigger marker to determine the contents having priority;
wherein the trigger marker includes at least one of an icon, metadata, audio data, a text, coordinates, and a pixel information.

81. The method of claim 79, wherein:
the content having priority includes a first content and a second content;
the first content and the second content are of different types of content.

82. The method of claim 81, wherein the presenting signal further includes an identifier configured to differentiate the first content and the second content, or further comprising:
identifying a reference marker on the communication application; and
identifying a trigger marker of the second content.

83. The method of claim 82, wherein the reference marker includes at least one of an icon, metadata, audio data, a text, coordinates, and a pixel information; and the trigger marker includes at least one of an icon, metadata, audio data, a text, coordinates, and a pixel information, or
wherein the reference marker is further configured to determine an event of the communication application, or
wherein element data of the first content and the second content are included in a display window of the communication application, or
wherein the element data is an image data; size, shape, and position of the element data of the second content are configured to change in the display window; and position of the reference marker on the display window remain the same, or
wherein the second content is identified according to a relation between the reference marker and the trigger marker on the display window.
